(19) United States
(12) Patent Application Publication
(10) Pub. No.: US 2008/0018577 A1
(43) Pub. Date: Jan. 24, 2008

(54) Display element having individually turned-on steps

(76) Inventors: Peter James Fricke, Corvallis, OR (US); Alan R. Arthur, Corvallis, OR (US); Joseph W. Stellbrink, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/492,164

(22) Filed: Jul. 23, 2006

(51) Int. Cl. G09G 3/36

(52) U.S. Cl. 345/88

(57) ABSTRACT

A display element corresponds to a pixel of a display. The display element includes a top electrode connected to a first addressable line of the display, and a bottom electrode connected to a second addressable line of the display. The display element includes a display mechanism situated between the top electrode and the bottom electrode and having a number of individually turned-on steps. Each individually turned-on step has a turn-on voltage threshold at which the step is turned on upon a voltage applied between the top and the bottom electrodes equal to or greater than the turn-on voltage threshold. Each individually turned-on step has a turn-off voltage threshold at which the step is turned off upon a voltage applied between the top and the bottom electrodes equal to or less than the turn-off voltage threshold.

### BACKGROUND

The most common type of display device requires the individual display elements of the display device to be refreshed a number of times per second to maintain the picture being displayed. If power is removed from the display device, then no picture can be displayed on the display device. Another type of display device is one that only requires that power be provided to the display device when the picture displayed on the device is modified or changed. Otherwise, a static image remains displayed on the display device substantially indefinitely even in the absence of power to the display device.

The latter type of display device includes those implemented using bi-stable display elements. Bi-stable display elements have an on state, in which the display element is on and displaying image data, and an off state, in which the display element is off and not displaying image data. Because such bi-stable display elements have just two states, a number of independently addressable elements may be needed to implement a single pixel of a display device. For instance, to implement a single color of a pixel having eight bits of color depth, three such bi-stable display elements may be needed, since 2³ equals eight.

To realize a display device using such bi-stable display elements in which each pixel includes three colors, red, green, and blue, and has eight, sixteen, or more bits of color bits, a large number of bi-stable display elements may be needed. This in turn means that a large number of addressable lines have to be connected to the display elements, since each display element is independently addressable. The resulting display device, however, may be difficult to cost effectively manufacture, owing to the large number of bi-stable display elements and the large number of addressable lines connected to these elements.

### BRIEF DESCRIPTION OF THE DRAWINGS

FIGS. 1A and 1B are diagrams of a front view and a cross-sectional top view, respectively, of a display element having a number of independently turned-on steps, according to an embodiment of the invention.

FIG. 2 is a graph depicting the positive turn-on voltage thresholds and the negative turn-off voltage thresholds of the display element of FIGS. 1A and 1B, according to an embodiment of the invention.

FIG. 3 are each a diagram of a cross-sectional top view of a display element having a number of independently turned-on steps, according to different embodiments of the invention.

FIG. 4 is a diagram of a rudimentary display device, according to an embodiment of the invention.

FIG. 5 is a flowchart of a rudimentary method, according to an embodiment of the invention.

### DETAILED DESCRIPTION OF THE DRAWINGS

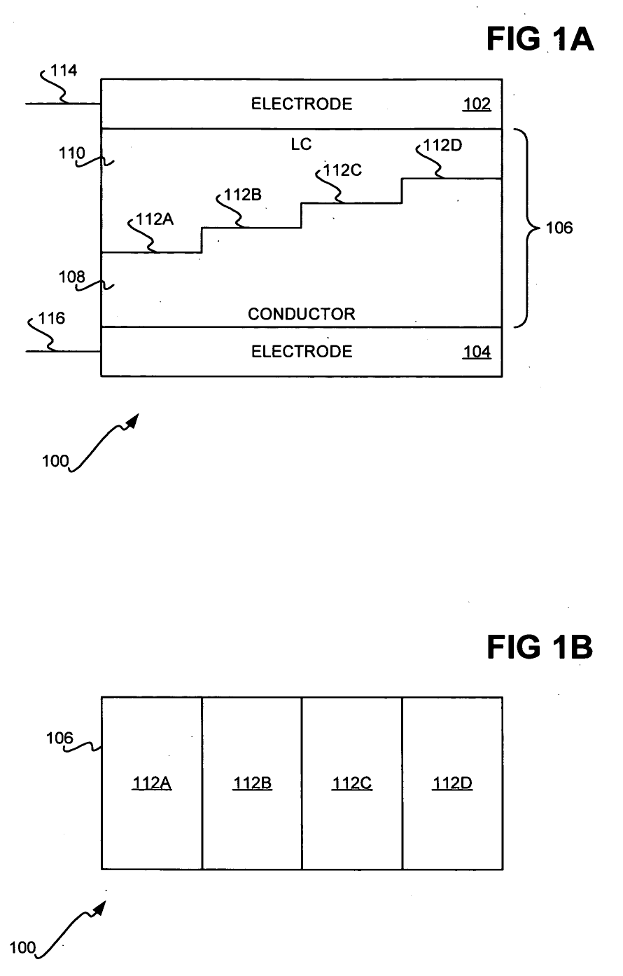

FIGS. 1A and 1B show a front view and a cross-sectional top view, respectively, of a display element 100 corresponding to a pixel of a display, according to an embodiment of the invention. The display element 100 includes a top electrode 102 and a bottom electrode 104. The top electrode 102 is connected to a first addressable line 114 of the display, and the bottom electrode 104 is connected to a second addressable line 116 of the display.

Between the electrodes 102 and 104 is a display mechanism 106. In the embodiment of FIGS. 1A and 1B, the display mechanism 106 includes a conductive layer 108 and a liquid crystal layer 110. The conductive layer 108 may be polyethylenedioxythiophene (PEDOT), or another type of conductive layer. The liquid crystal layer 110 may be a post aligned bi-stable nematic (PABN) liquid crystal layer, or another type of liquid crystal layer. The display element 100 is bi-stable, in that once it has been turned on by applying a voltage between the electrodes 102 and 104, the element 100 remains in its current state, until it is turned off. That is, a voltage does not have to be continually applied between the electrodes 102 and 104 for the element 100 to remain in its current state, once the element 100 has been switched to that state. Stated another way and most generally, the display element 100 remains in its current state until a voltage is applied to change the state of the display element 100.

The display mechanism 106 has a number of individually turned-on steps 112A, 112B, 112C, and 112D, collectively referred to as the individually turned-on steps 112. While there are four such steps 112 in the example of FIGS. 1A and 1B, in other embodiments there may be more or less of the steps 112. The steps 112 are individually turned on in that each of the steps 112 may be turned on, and display image data, while the other of the steps 112 remain off, as will be described in more detail later in the detailed description. When a given step is turned on, it displays image data, and when a given step is turned off, it does not display image data. As depicted in FIG. 1B in particular, each of the steps 112 corresponds to a different area of the display mechanism 106.

The steps 112 can further correspond to different pillars or other types of structures within the display mechanism 106. That is, the terminology step as used herein is used in a broad, encompassing sense. As such, this terminology encompasses different types of structures that can be implemented within the display mechanism 106, such as pillars.

The individually turned-on steps 112 are defined by varying the heights of the layers 108 and 110, from top to bottom in FIG. 1A, along the width of the display element 100, from left to right in both FIGS. 1A and 1B. Although each of the steps 112 has the same width from left to right in FIGS. 1A and 1B, in another embodiment, the steps 112 may have different widths. The smaller the gap between a given step of the conductive steps 112 and the opposing electrode 102, the lower the required voltage to turn on that step. Thus, the steps 112A, 112B, 112C, and 112D have positive turn-on voltage thresholds PVA, PVB, PVC, and PVD, respectively, where PVA>PVB>PVC>PVD. Therefore, a given applied positive voltage PV between the electrodes 102 and 104 turns on all the steps having positive turn-on voltage thresholds equal to or less than the positive voltage PV.

Furthermore, the larger the gap between a given step of the conductive steps 112 and the opposing electrode 102 in FIG. 1A, the greater the negative voltage that is needed to be applied between the electrodes 102 and 104 to turn off that step. Thus, the steps 112A, 112B, 112C, and 112D have negative turn-off voltage thresholds NVA, NVB, NVC, and NVC, respectively, where |NVA|>|NVB|>|NVC|>|NVD|, where |x| is the absolute value of x. Thus, if the (negative) signage of the voltage thresholds are taken into account, then NVA<NVB<NVC<NVD. Therefore, a given applied negative voltage NV between the electrodes 102 and 104 turns off all the steps having negative turn-off voltage thresholds having absolute magnitudes equal to or less than the absolute magnitude of the negative voltage NV.

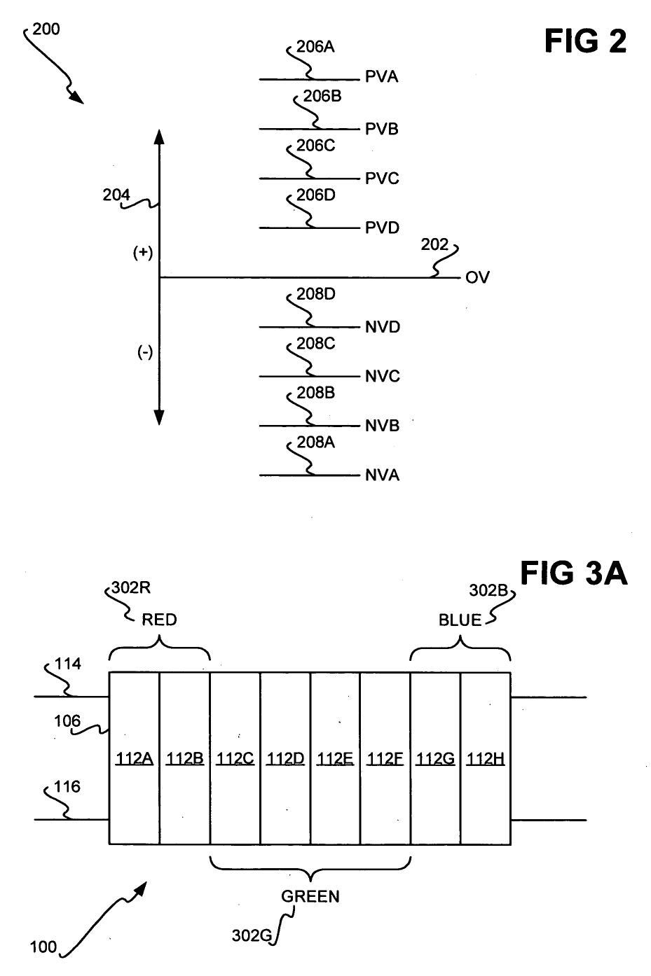

FIG. 2 shows a graph 200 that illustratively depicts the positive turn-on voltage thresholds and the negative turn-off voltage thresholds of the steps 112 of the display mechanism 106 of the display element 100, according to an embodiment of the invention. The x-axis 202 corresponds to zero voltage, whereas the y-axis 204 above the x-axis 202 corresponds to positive voltages, and the y-axis 204 below the x-axis 202 corresponds to negative voltages, as is conventional. The positive voltage thresholds PVA, PVB, PVC, and PVD for the steps 112 are denoted by the lines 206A, 206B, 206C, and 206D, whereas the negative voltage threshold NVA, NVB, NVC, and NVD for the steps 112 are denoted by the lines 208A, 208B, 208C, and 208D.

Thus, the positive turn-on voltage thresholds for the steps 112 are ordered from a lowest turn-on voltage threshold PVD to a highest turn-on voltage threshold PVA. No two of the positive turn-on voltage thresholds are equal to one another. A positive voltage applied between the electrodes 102 and 104 turns on those of the steps 112 having positive turn-on voltage thresholds less than or equal to the positive voltage applied.

Likewise, the negative turn-off voltage thresholds for the steps are ordered from a highest, or greatest, or least negative turn-off voltage NVD to a lowest, or most negative turn-off voltage NVA. No two of the negative turn-off voltage thresholds are equal to one another. A negative voltage applied between the electrodes 102 and 104 turns off those of the steps 112 having negative turn-off voltage thresholds having absolute magnitudes less than or equal to the absolute magnitude of the negative voltage applied.

For example, consider the situation in which just the step 112B is desired to be turned on. First, a positive voltage PV is applied between the electrodes 102 and 104 of FIG. 1, where PVB<PV<PVA. Because the positive voltage PV is greater than the positive turn-on voltage thresholds PVD, PVC, and PVB for the steps 112D, 112C, and 112B, respectively, all three of the steps 112D, 112C, and 112B are turned on. The step 112A remains off, because its positive turn-on voltage threshold PVA is greater than the positive voltage PV applied.

Next, a negative voltage NV is applied between the electrodes 102 and 104, where NVC>NV>NVB. Because the negative voltage NV is less than the negative turn-off voltage thresholds NVC and NVD for the steps 112C and 112D, respectively, both of the steps 112C and 112D are turned off. That is, the negative voltage NV has an absolute magnitude such that |NVD|<|NVC|<|NV|<|NVB|, where |x| denotes the absolute magnitude of x. The step 112B remains on, because its negative turn-off voltage threshold NVB is less than the negative voltage NV applied (i.e., the absolute magnitude of NVB is greater than the absolute magnitude of NV). The step 112A still remains off, as before. Thus, just the step 112B is ultimately turned on. If the step 112D is also to be turned on, in addition to the step 112B, a second positive voltage PV is applied, where PVD<=PV<PVC.

In general, the steps 112 are turned on in a desired combination as follows. First, a positive voltage is applied that is equal to or greater than the step having the highest positive turn-on voltage threshold that is to be turned on. This positive voltage turns on all the steps having positive turn-on voltage thresholds less than the positive voltage applied. Next, a negative voltage is applied that is equal to or less than the step having the lowest, most negative turn-off voltage threshold that has been turned on but should be turned off. That is, a negative voltage is applied that has an absolute magnitude that is greater than or equal to the step having a turn-off voltage threshold that has the highest absolute magnitude and that has been turned on but should be turned off. This negative voltage turns off all the steps having negative turn-off voltage thresholds having absolute magnitudes less than the absolute magnitude of the negative voltage applied. This process is then repeated for the step having the next-highest positive turn-on voltage threshold that is to be turned on, the next-lowest negative turn-off voltage threshold (i.e., the negative turn-off voltage having the next-highest absolute magnitude) that is to be turned off, and so on, until the steps 112 have been turned on in the desired combination.

For example, consider the situation where the steps 112A and 112C are to be turned on, and the steps 112B and 112D are to remain off. A positive voltage is applied that is equal to or greater than PVA, the positive turn-on voltage threshold for the step 112A. This turns on all the steps 112. Next, a negative voltage is applied that is equal to or less than NVB, the negative turn-off voltage threshold for the step 112B, but greater than NVA, the negative turn-off voltage threshold for the step 112A. (That is, the negative voltage has an absolute magnitude that is equal to or greater than the absolute magnitude of NVB, but that is less than the absolute magnitude of NVA.) This turns off the steps 112B, 112C, and 112D, while the step 112A remains on.

However, the step 112C is also to be turned on. Therefore, another positive voltage is applied, which is equal to or greater than PVC, the positive turn-on voltage threshold for the step 112C, but is less than PVB, the positive turn-on voltage threshold for the step 112B. This turns on the steps 112C and 112D. However, the step 112D is not supposed to be turned on. Therefore, a negative voltage is applied that is equal to or less than NVD, the negative turn-off voltage threshold for the step 112D, but greater than NVC, the negative turn-off voltage threshold for the step 112C. (I.e., the negative voltage has an absolute magnitude that is greater than the absolute magnitude of NVD, but less than the absolute magnitude of NVC.) This turns off the step 112D, while the steps 112A and 112C remain on, and the step 112B remains off.

This process of sequentially turning on and off the steps 112 so that any combination of the steps 112 is on provides the display element 100 to have a bit depth, such as a grayscale bit depth, that is greater than the number of the steps 112 themselves. For instance, in the examples that have been described, there are four of the steps 112. However, because any combination of these steps 112 can be turned on, the display element 100 has a bit depth of 2⁴, or sixteen. That is, the steps 112 can be individually turned on and off as desired using the process that has been described above, to realize a display element 100 that has a bit depth equal to all the different combinations of the steps 112 being turned on or off.

Therefore, the display element 100 is advantageous as compared to prior art bi-stable display elements, because it provides for multiple individually turned-on steps within a single display element addressable by a pair of addressable lines 114 and 116 of a display. For instance, as has been described in relation to FIGS. 1A, 1B, and 2, the display element 100 has four steps 112. Each of these four steps 112 can be individually turned on or off by applying an appropriate positive and/or negative voltage between the electrodes 102 and 104. A voltage is applied between the electrodes 102 and 104 by asserting a voltage between the addressable lines 114 and 116 of the display. Thus, all four of the steps 112 are controlled via the same two addressable lines 114 and 116.

By comparison, in the prior art, four such individually turned-on steps would be realized by having individual pairs of addressable lines for each of these steps. In effect, a separately addressable display element would implement each of the steps within the prior art. As such, embodiments of the invention provide for a significant reduction in the number of addressable lines that are needed for each realized individually turned-on step. For instance, the embodiment described in relation to FIGS. 1A, 1B, and 2 provides for a reduction in the number of addressable lines by a factor of four, simplifying the resultant display device and decreasing its manufacturing costs.

In one embodiment, each of the individually turned-on steps of a display element corresponds to a single color of a pixel of a display. For instance, the steps of the display element may correspond to the color red of the pixel, the color green of the pixel, or the color blue of the pixel. As such, the steps provide for multiple-bit contrast depth of the display element for this color of the pixel. For example, where there are N steps, the steps provide for 2^{N}-bit contrast depth for the color of the pixel to which the display element corresponds.

In another embodiment, the individually turned-on steps of a display element may be divided into groups, where each group corresponds to a different color of a pixel of a display to which the display element itself corresponds. For instance, the steps of the display element may be grouped into three groups: a red group corresponding to the color red of the pixel, a green group corresponding to the color green of the pixel, and a blue group corresponding to the color blue of the pixel. In this way, the steps provide for multiple-bit contrast depth of the display element for each of the three colors of the pixel. For example, where there are R steps in the red group, G steps in the green group, and B steps in the blue group, the steps provide for 2^{R}-bit contrast depth for red, 2^{G}-bit contrast depth for green, and 2^{B}-bit contrast depth for blue of the pixel to which the display element corresponds.

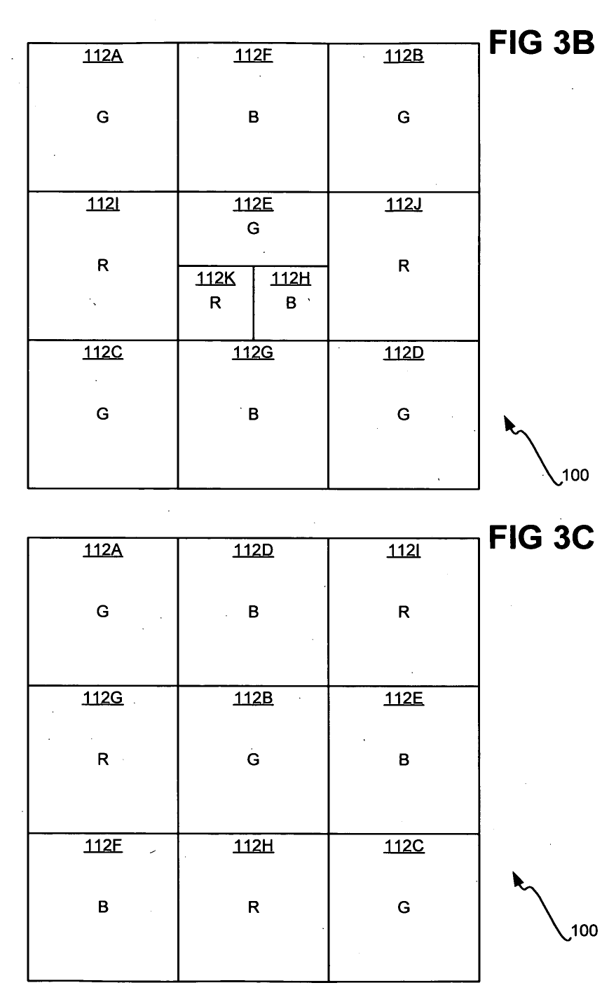

FIG. 3A shows a cross-sectional top view of the display element 100 where the individually turned-on steps 112 are divided into groups corresponding to the different colors of a pixel of a display, according to an embodiment of the invention. In the embodiment of FIG. 3A, there are eight steps 112. The two steps 112A and 112B belong to the red group 302R, the four steps 112C, 112D, 112E, and 112F belong to the green group 302G, and the two steps 112G and 112H belong to the blue group 302B. As such, the pixel of the display to which the display element of FIG. 3A corresponds has 2²=4-bit contrast depth for each of red and blue, and 2⁴=16-bit contrast depth for green. In FIG. 3A, the steps 112 are contiguously organized from left to right of the display element 100, such that each of the steps 112 extends from front to back of the display element 100.

FIG. 3B shows a cross-sectional top-view of the display element 100 where the individually turned-on steps 112 are divided into groups corresponding to different colors of a pixel of a display, according to another embodiment of the invention. In the embodiment of FIG. 3B, there are eleven steps 112. The steps 112A, 112B, 112C, 112D, 112F, 112G, 112I, and 112K are each equally sized. The step 112E is half the size of the step 112A. The steps 112H and 112K are each half the size of the step 112E.

The steps 112A, 112B, 112C, 112D, and 112E belong to a green group. The steps 112F, 112G, and 112H belong to a blue group, and the steps 112I, 112J, and 112K belong to a red group. The area of the green group is twice that of the area of the blue group. The area of the blue group is equal to the area of the red group. Thus, twice as much contrast depth is provided for green as for red or blue within the display element of FIG. 3B. The different steps 12 are discontiguously organized over the entirety of the display element in FIG. 3B.

FIG. 3C shows a cross-sectional top view of the display element 100 where the individually turned-on steps 112 are divided into groups corresponding to different colors of a pixel of a display, according to another embodiment of the invention. In the embodiment of FIG. 3C, there are nine equally sized steps 112. The steps 112A, 112B, and 112C belong to a green group, the steps 112D, 112E, and 112F belong to a blue green, and the steps 112G, 112H, and 112I belong a blue group. The areas of the green, blue, and red groups are equal to one another, such that each color has the same contrast depth within the display element of FIG. 3C. The different steps 112 are discontiguously organized over the entirety of the display element in FIG. 3C.

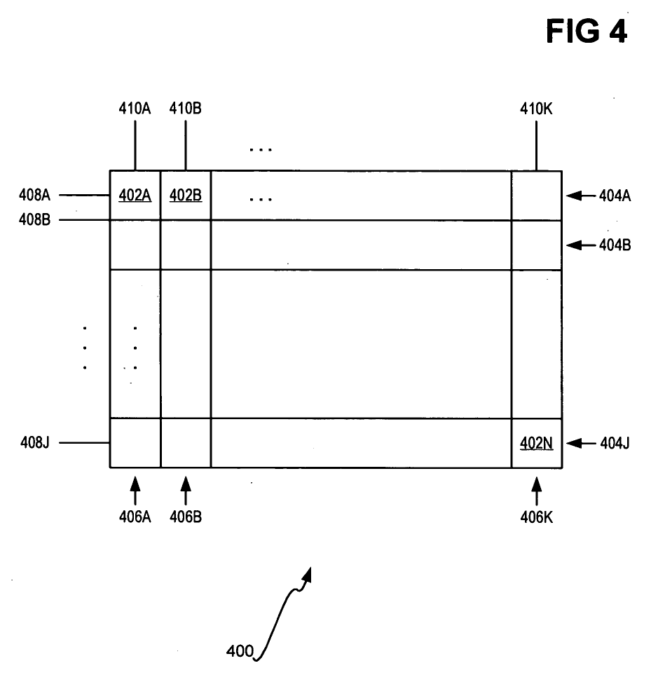

FIG. 4 shows a representative display device 400, according to an embodiment of the invention. The display device 400 includes a number of display elements 402A, 402B, . . . , 402N, collectively referred to as the display elements 402, and which correspond to the pixels of the display device 400. The display elements 402 are organized in rows 404A, 404B, . . . , 404J, collectively referred to as the rows 404, and columns 406A, 406B, . . . , 406K, collectively referred to as the columns 406.

Each of the display elements 402 can be implemented as the display element 100 as has been described. The display elements 402 can be bi-stable display elements, such that they retain their current states being displayed even if power is removed from the elements 402. Thus, power is needed only to change the states of the display elements 402, and not to retain the states of the display element 402.

The display device 400 also includes addressable lines 408A, 408B, . . . , 408J, collectively referred to as the addressable lines 408 and corresponding to the rows 404 into which the display elements 402 are organized. The display device 400 further includes addressable lines 410A, 410B, . . . , 410K, collectively referred to as the addressable line 410 and corresponding to the columns 406 into which the display elements 402 are organized. The display device 400 can and typically will include other components, in addition to the display elements 402 and the addressable lines 408 and 410, as can be appreciated by those of ordinary skill within the art.

The addressable lines 408 are connected to all of the display elements 402 within their respective rows 404. Thus, the addressable line 408A is connected to all of the display elements 402 within the row 404A, the addressable line 408B is connected to all of the display elements 402 within the row 404B, and so on. Similarly, the addressable lines 410 are connected to all of the display elements within their respective columns 406. Thus, the addressable line 410A is connected to all of the display elements 402 within the column 406A, the addressable line 410B is connected to all of the display elements 402 within the column 406B, and so on.

In this way, each of the display elements 402 is addressable by a unique pair of addressable lines, including one of the addressable lines 408 and one of the addressable lines 410. That is, no two display elements are connected to both the same one of the addressable lines 408 and the same one of the addressable lines 410. To change the state of a given display element, positive and/or negative voltages are applied between the addressable lines to which the display element in question is connected. This process is performed for each of the display elements 402, to change the states of all of the display elements 402.

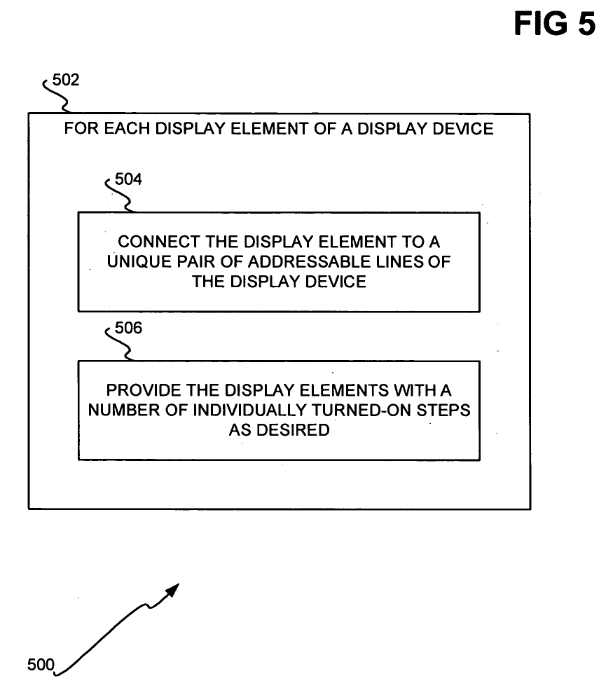

FIG. 5 shows a rudimentary method 500, according to an embodiment of the invention. As indicated by part 502 of the method 500, the method 500 is performed for each display element of a display device that corresponds to a pixel of the display device. First, the display element in question is connected to a unique pair of the addressable lines of the display device (504), such as has been described in relation to FIG. 4. Second, the display element is provided with a number of individually turned-on steps as desired (506), as has been described above.

Embodiments of the invention thus provide for advantages over other approaches to achieve multiple-bit contrast depth display elements, particularly to achieve multiple-bit contrast depth bi-stable display elements. Within the prior art, a given bi-stable display element has just two states, on and off. As a result, to achieve multiple-bit contrast depth, a number of such display elements may need to be used to correspond to a given pixel or a given pixel color. However, where these display elements each is addressable by a unique pair of addressable lines of the display device, the resulting number of addressable lines needed can be quite large, resulting in a cost-prohibitive display device design.

By comparison, embodiments of the invention provide for a bi-stable display element that has more than two states. Multiple-bit contrast depth can then be achieved by using a single display element. All of the states of such a display element are controlled by the same unique pair of addressable lines of the display device connected to this display element. As a result, as compared to the prior art, less addressable lines are needed to achieve the same multiple-bit contrast depth, which renders the resulting display device design more cost effective.

We claim:

1. A display element corresponding to a pixel of a display, comprising:
a top electrode connected to a first addressable line of the display;
a bottom electrode connected to a second addressable line of the display; and,
a display mechanism situated between the top electrode and the bottom electrode and having a plurality of individually turned-on steps,
wherein each individually turned-on step has a turn-on voltage threshold at which the step is turned on upon a voltage applied between the top and the bottom electrodes equal to or greater than the turn-on voltage threshold,
wherein each individually turned-on step has a turn-off voltage threshold at which the step is turned off upon a voltage applied between the top and the bottom electrodes equal to or less than the turn-off voltage-threshold,
and wherein the individually turned-on steps each correspond to a different color of the pixel, as one of red, green, and blue.

2. The display element of claim 1, wherein the individually turned-on steps correspond to different areas of the display mechanism.

3. The display element of claim 1, wherein the corresponding turn-on voltage thresholds of the individually turned-on steps are ordered from a lowest turn-on voltage threshold to a highest turn-on voltage threshold, such that no two of the turn-on voltage thresholds are equal to one another, and such that the voltage applied between the top and the bottom electrodes turns on those of the individually turned-on steps having the turn-on voltage thresholds less than or equal to the voltage applied.

4. The display element of claim 1, wherein the corresponding turn-on voltage thresholds of the individually turned-on steps are positive voltage thresholds, and wherein the corresponding turn-off voltage threshold of the individually turned-on steps are negative voltage thresholds.

5. The display element of claim 4, wherein the corresponding negative turn-off voltage thresholds of the individually turned-on steps are ordered from a highest turn-off voltage threshold to a lowest turn-off voltage threshold, such that no two of the negative turn-off voltage thresholds are equal to one another, and such that a negative voltage applied between the top and the bottom electrodes turns off those of the individually turned-on steps having the negative turn-off voltage thresholds greater than or equal to the negative voltage applied.

6. The display element of claim 1, wherein the display element has a grayscale bit depth greater in number than the individually turned-on steps.

7. The display element of claim 1, wherein the individually turned-on steps are grouped into a plurality of groups, each group including at least two of the individually turned-on steps and corresponding to a different color of the pixel, as one of red, green, and blue, such that the individually turned-on steps provide for multiple-bit contrast depth for each different color of the display element.

8. The display element of claim 7, wherein the plurality of groups comprises a first group having two of the individually turned-on steps and corresponding to red, a second group having four of the individually turned-on steps and corresponding to green, and a third group having two of the individually turned-on steps and corresponding to blue.

9. The display element of claim 1, wherein the display mechanism comprises:
a post aligned bi-stable nematic (PABN) liquid crystal layer; and,
a conductive layer.

10. The display element of claim 1, wherein the display element is a bi-stable display element.

11. A display device comprising:
a plurality of first addressable lines;
a plurality of second addressable lines; and,
a plurality of display elements corresponding to a plurality of pixels of the display device, each display element connected to one of the first addressable lines and one of the second addressable lines, such that no two of the display elements are connected to a same one of the first addressable lines and a same one of the second addressable lines,
wherein each display element has a plurality of individually turned-on steps, each individually turned-on step having a positive turn-on voltage threshold at which the step is turned on upon a positive voltage applied between the first addressable line and the second addressable line to which the display element is connected that is equal to or greater than the positive turn-on voltage threshold,
wherein each individually turned-on step has a negative turn-off voltage threshold at which the step is turned off upon a negative voltage applied between the first addressable line and the second addressable line to which the display element is connected that is equal to or less than the negative turn-off voltage threshold,
and wherein the individually turned-on steps each correspond to a different color of the pixel, as one of red, green, and blue.

12. The display device of claim 11, wherein each display element comprises:
a top electrode connected to one of the first addressable lines;
a bottom electrode connected to one of the second addressable lines;
a liquid crystal layer; and,
a conductive layer,
wherein the liquid crystal layer and the conductive layer have a plurality of areas corresponding to the plurality of individually turned-on steps.

13. The display device of claim 11, wherein the display element has a grayscale bit depth greater in number than the individually turned-on steps.

14. The display device of claim 11, wherein the individually turned-on steps together all correspond to a single color of the pixel, as one of red, green, and blue, such that the individually turned-on steps provide for multiple-bit contrast depth of the display element.

15. The display device of claim 11, wherein the individually turned-on steps are grouped into a plurality of groups, each group including at least two of the individually turned-on steps and corresponding to a different color of the pixel, as one of red, green, and blue, such that the individually turned-on steps provide for multiple-bit contrast depth for each different color of the display element.

16. A method comprising:
for each display element of a plurality of display elements of a display device corresponding to a plurality of pixels of the display device,
connecting the display element to a first addressable line of the display and a second addressable line of the display device, such that no two of the display elements are connected to a same first addressable line and a same second addressable line; and,
providing a plurality of individually turned-on steps of the display element, each individually turned-on step having a positive turn-on voltage threshold at which the step is turned on upon a positive voltage applied between the first and the second addressable lines equal to or greater than the positive turn-on voltage threshold, and each individually turned-on step having a negative turn-off voltage threshold at which the step is turned off upon a negative voltage applied between the first and the second addressable lines equal to or less than the negative turn-off voltage threshold,
wherein the individually turned-on steps each correspond to a different color of the pixel, as one of red, green, and blue.

17. The method of claim 16, wherein the corresponding positive turn-on voltage thresholds of the individually turned-on steps of each display element are ordered from a lowest turn-on voltage threshold to a highest turn-on voltage threshold, such that no two of the turn-on voltage thresholds of the display element are equal to one another, and such that the positive voltage applied between the first addressable line and the second addressable line to which the display element is connected turns on those of the individually turned-on steps having the positive turn-on voltage thresholds less than or equal to the positive voltage applied.

18. The method of claim 16, wherein the corresponding negative turn-off voltage thresholds of the individually turned-on steps of each display element are ordered from a highest turn-off voltage threshold to a lowest turn-off voltage threshold, such that no two of the negative turn-off voltage thresholds of the display element are equal to one another, and such that a negative voltage applied between the first addressable line and the second addressable line to which the display element is connected turns off those of the individually turned-on steps having the negative turn-off voltage thresholds greater than or equal to the negative voltage applied.
